(19) United States
(12) Patent Application Publication
(10) Pub. No.: US 2007/0119642 A1
(43) Pub. Date: May 31, 2007

(54) Bug off clip screen

(76) Inventors: Judy E. Williams, Churchville, VA (US); James C. Williams JR., Churchville, VA (US)

Correspondence Address: Judy E. Williams, P.O. Box 36, Churchville, VA, 24421, US

(21) Appl. No.: 11/294,884

(22) Filed: Nov. 16, 2005

(51) Int. Cl. B60K 11/04

(52) U.S. Cl. 180/68.6

(57) ABSTRACT

The present invention is a clip-in-place screening device for an automotive, industrial, or agricultural vehicle that is used to filter out insects and other debris from the fins of air conditioner condensers, coolers, and air-charge coolers placed in front of radiators.

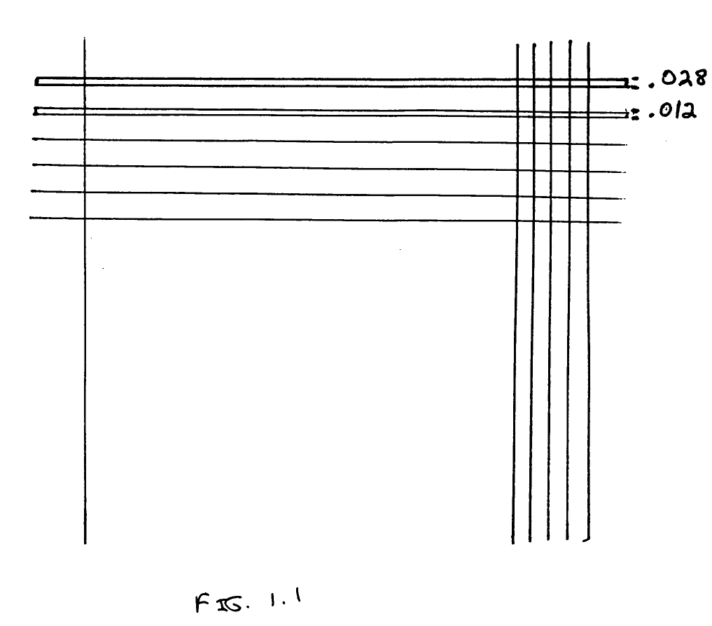

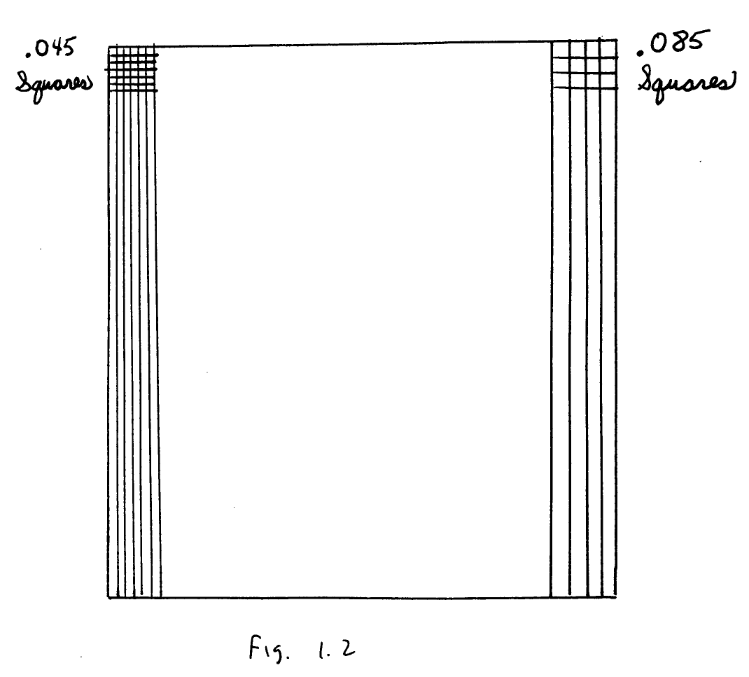

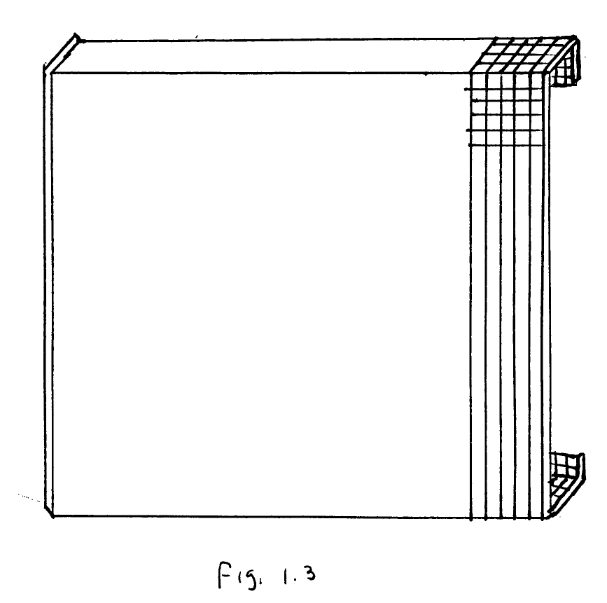

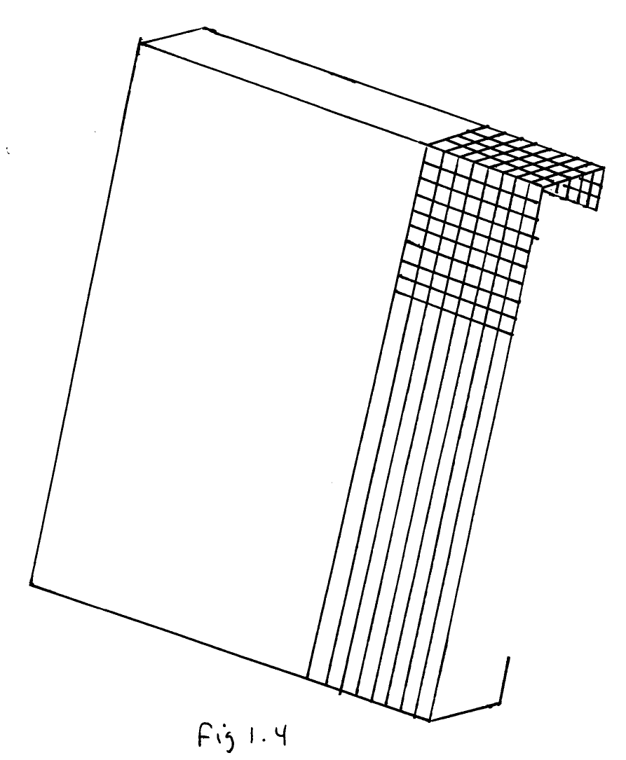

### REFERENCES CITED

| | | | |
|---|---|---|---|
| 20020088656 | Bergman | Jul. 11, 2002 | 180/68.3 |
| 6,361,093 | Garberg | Mar. 26, 2002 | 293/115 |
| 20040198115 | McGregor, et al. | Oct. 7, 2004 | 442/6 |
| 20020069624 | Jaramillo, et al. | Jun. 13, 2002 | 55/385.3 |
| 6,589,307 | Jaramillo, et al. | Jul. 8, 2003 | 55/385.3 |
| 20050029028 | Steinmacher | Feb. 10, 2005 | 180/68.6 |

### FEDERALLY SPONSORED RESEARCH OR DEVELOPMENT

Not Applicable

### SEQUENCE LISTING, TABLE, OR COMPUTER PROGRAM LISTING COMPACT DISK APPENDIX

Not Applicable

### BACKGROUND OF INVENTION

The present invention relates generally to a clip-in-place screening device for a vehicle that is used to filter out insects and other debris from a vehicle and more specifically to the use of this device in various pickup trucks, passenger cars, industrial, and agricultural vehicles to keep the fins of air conditioning condensers, coolers, and air-charged coolers in front of radiators free of insects and debris.

As insects and other debris enter into the small fins that connect to the tubes in air conditioner condensers, air-charged coolers, and radiators, they choke off the air supply that these units need to dissipate the heat for their different functions. The unit closest to the point of entry in front of the radiator in most vehicles is the one that encounters the greatest amount of insects and debris. If the front-most unit is smaller than the one behind it, then a screen on each is roost efficient in protecting these units from the entry of bugs and debris.

The present inventors' career and observations in the field of motor vehicle maintenance and repair have allowed them first-hand experience and observation in the resulting damage of these foreign objects and the importance of either cleaning out or preventing insects and debris from collecting in air conditioning condensers, air-charged coolers, and radiator fins. The present invention is a method and apparatus for preventing the insects and debris from entering in the first place.

The majority of such screens typically bolt in place, whereas the present invention clips in place. Bolting a screen in place requires a higher degree of skill from the auto owner and equipment operators or mechanical technicians. The clip on mounting system of the present invention is quite simple.

### BRIEF SUMMARY OF THE INVENTION

The present invention is a screen (an apparatus) for providing a method for filtering out insects and debris and preventing such foreign objects from packing tightly and deeply within the fins of the cooling units that are vital for the heat dissipation of air conditioning condensers, any cooler, or air-charged cooler (which will be further referenced simply as “units”) in front of radiators in automotive, industrial, and agricultural vehicles. This screen is specially bent for dipping over these units and will vary in sizes, depending on the application for air flow needs and sizes needed to cover the units.

### BRIEF DESCRIPTION OF THE DRAWINGS

1.1 A screen with various wire diameters;

1.2 A screen with various opening sizes to accommodate air flow needs;

1.3 A screen with two 90 degree bends and the top and bottom, which allow the screen to hook over the top and bottom of units to hold it in place;

1.4 An edging crimped around the perimeter of the screen to strengthen it and to keep it from fraying at the edges.

### DETAILED DESCRIPTION OF INVENTION

The majority of all automobile, industrial and agricultural machines have several units in place that depend on air passing through heat dissipating units by the speed at which the machine is traveling and by a fan moving air through these units. When debris, such as seeds, weeds, trash, or insects crash into the fins at high rates of speed and pack deeply back into the fins and around the tubes in the cooling systems, air flow is impaired and the cooling systems fail to function properly. This causes air conditioning systems, air-charged coolers and radiators to perform below par. Air conditioning systems blow hot air, power drops on the engine, because the air from the intake system is improperly cooled, and engines begin to overheat, which causes costly repairs and even premature engine failure.

The present invention eliminates most of these problems by filtering out insects and debris before they can enter these units. As the present invention is a clip-on screen, without brackets, screws or bolts, it can be easily removed for cleaning and replacement. This screen also prevents costly cleaning associated with the removal of the insects and debris that have packed deeply and tightly into the fins. The screen is capable of clipping over both the top and bottom of these units, because of the unique bends at the top and bottom of the screen. There are two, 90 degree bends at both the top and bottom, allowing the screen to hook over the top and bottom and catch the back of these units to hold it firmly in place. A crimped edge prevents fraying on the edges and strengthens the screen.

What we claim as our invention is:

1. A screen to prevent insects and debris from entering a vehicle and packing deeply and tightly into the fins and around tubes found in air conditioning condensers, coolers, and air-charged coolers that are mounted in front of radiators.

2. The screen of claim 1 is made in varying square sizes, wire sizes, and outside measurements.

3. The screen of claim 1 has two 90 degree bends at the top and two 90 degree bends at the bottom

4. The bends referenced in claim 3 allow the screen to remain securely in place by dipping over the top and the bottom and catching the back of air conditioning condensers, coolers, and air-charged coolers that are mounted in front of radiators on automotive, industrial, and agricultural equipment for the purpose of filtering out insects and debris.
